(19) United States
(12) Patent Application Publication
(10) Pub. No.: US 2003/0010194 A1
(43) Pub. Date: Jan. 16, 2003

(54) Control device for a hydraulic control motor

(76) Inventor: J?ouml;rg Linser, (US)

Correspondence Address: KENYON & KENYON, ONE BROADWAY, NEW YORK, NY, 10004, US

(21) Appl. No.: 10/203,314

(22) PCT Filed: Jan. 20, 2001
(86) PCT No.: PCT/EP01/00628

(30) Foreign Application Priority Data
Feb. 11, 2000 (DE) 100 06 141.9

(51) Int. Cl. F15B 11/08

(52) U.S. Cl. 91/420

(57) ABSTRACT

A control device for a hydraulic control motor includes at least one valve controlled actively by an actuating force and at least one passive valve which is operatively connected to the actively controlled valve and which is co-controlled via a line.

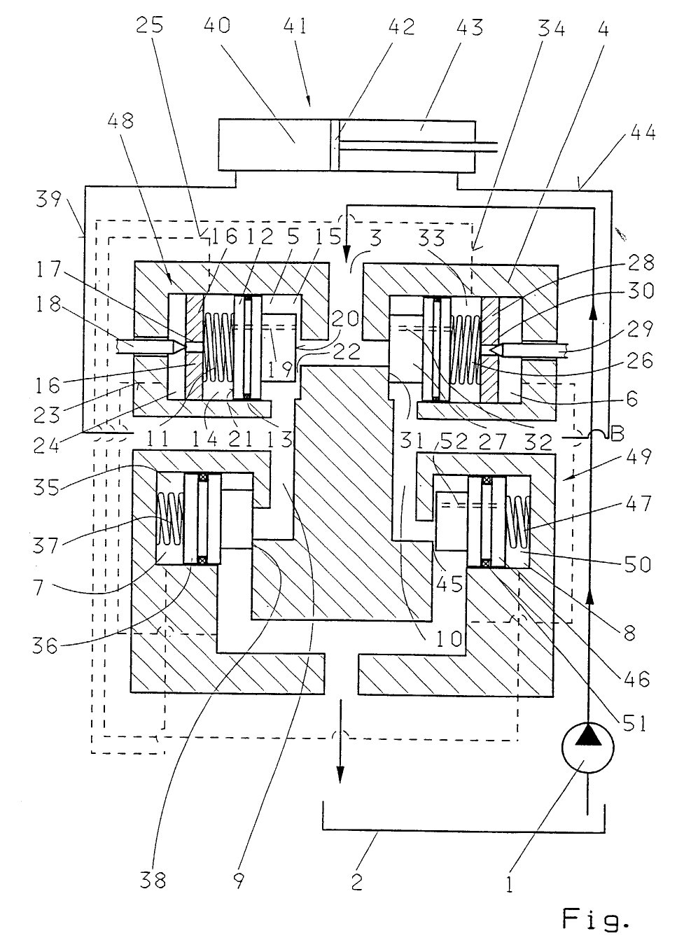

The invention relates to a control device of the type defined in more detail in the preamble of claim 1. Such a device is known from U.S. Pat. specification No. 3,714,868. This known device operates on the closed-center principle.

The object on which the present invention is based is to provide a control device which is suitable for operating on the open-center principle, but at the same time largely avoids leakages. It is also to be constructed in a simple way, operate reliably and be capable of being produced without a high outlay in manufacturing terms.

The object of which the invention is based is achieved by means of a generic control device also having the characterizing features of the main claim.

The bore is arranged in such a way that, when the piston is pressed against the housing by system pressure, the bore in the piston is closed, in order to avoid leakages.

By virtue of the invention, quantity-independent functioning can be ensured. The control device according to the invention can be used for various applications and can easily be adapted to changed requirements. It can be used, for example, for a hydraulic control motor, in particular when the activation of the latter functions on the open-center principle.

Advantageous and expedient refinements of the invention are described in the subclaims. However, the invention is not restricted to the feature combinations of the claims, but further appropriate possibilities for the combination of claims and individual claim features may be gathered from the set object by a person skilled in the art.

The invention allows a modular construction of the, in particular, electrohydraulic control device, so that a large number of parts can be used many times, which affords considerable advantages with regard to the outlay in terms of manufacturing and assembly terms. By virtue of the simple mechanically, electrically, electromagnetically, hydraulically or pneumatically. The pistons have special sealing elements which, in addition to performing their sealing function, also have bearing properties. They are produced preferably from resistant and low-wear materials, such as, for example, teflon. Integrated in the piston of the actively controlled valve is at least one bore which serves for the feed of pressure medium into a pressure space which is connected to the passive valve by a line.

### An exemplary embodiment of the present invention is described below, in principle, with reference to a figure.

The single figure shows a control device according to the invention which controls a hydraulic control motor.

A pressure medium conveyed out of a tank 2 by a pump 1 flows through an inflow bore 3 into a housing 4 having a plurality of bores 5,6,7,8 which are connected via lines 9,10. A piston 12 loaded by a spring 11 is mounted axially moveably in the bore 5. The piston 12 has a stepped outside diameter. A sealing element 13 in the piston 12 separates the bore 5 into two pressure spaces 14,15. The sealing element 13 also serves at the same time for the low-friction guidance of the piston 12. The spring 11 is supported on a disk-shaped element 16 connected firmly to the housing 4. The disk-shaped element 16 has a throttle point 17 which co-operates with a throttle needle 18 axially displaceable by an actuating force and thus allows a change in volume flow. The pressure medium flowing through the throttle point 17 flows through a further pressure space 24 and via a line 23 back to the tank.

If the volume flow in the inflow bore 3 is, for example, to be reduced or interrupted, the throttle needle 18 is pushed into the throttle point 17. The pressure medium then has to flow through a bore 19 arranged in the piston 12; on account of the smaller throughflow cross section of the throttle points 17 there is a pressure build-up in the pressure space 14. Beyond a defined pressure in the pressure space 14, a force equilibrium occurs between the pressure forces acting on end faces 20 and 21. The spring 11 has the task of pushing the piston 12, in the neutral position, against the housing 4 in such a way that, due to the throttling of the volume flow of the pressure medium in an annular gap 22, a predetermined pressure difference may arise, which, when a throttle effect occurs at the throttle point 17, brings about, on the end face 21 of the piston 12, a pressure force which overcomes the friction of the sealing element 13. When the force equilibrium is reached, the piston 12 moves in the direction of the inflow bore 3 owing to the force of the spring 11. The annular gap 22 located between the housing 4 and the end face 20 is thereby narrowed. As a result, the pressure of the pressure medium of the inflow bore 3 rises. The actuating force on the throttle needle 18 corresponds in amount to the pressure of the pressure medium in the pressure space 14, which, in turn, corresponds to the pressure of the pressure medium in the inflow bore 3. This gives rise to proportionality between the actuating force acting on the throttle needle 18 and the pressure of the pressure medium which is established in the inflow bore 3.

A further piston 27 pressure-loaded by a spring 26 is located in the bore 6 in the housing 4. Here, to, the spring 26 is supported on a disk-shaped element 28.

If the pressure medium is to be led to a pressure space 40 of a hydraulic control motor 41 via a line 39, then a throttle needle 29 must close a throttle point 30, with the result that an annular gap 31 is closed. The pressure medium flows through a bore 32 into a pressure space 33 and from there further on, via a line 34, into a pressure space 35 which is formed by a piston 36, axially displaceable in the bore 7, and the housing 4. The piston 36 pressure-loaded by a spring 37 closes an annular gap 38. A piston 42 of the hydraulic control motor 41 is displaced and the pressure medium is led further on from a second pressure space 43 via a line 44 to the line 10 in the housing 4. The pressure medium can flow off to the tank 2 via an open annular gap 45 which occurs between the housing 4 and a piston 46 axially displaceable in the bore 8 and loaded by a spring 47.

A pressure space 50, which is formed by the housing 4 and the piston 46 pressure-loaded by a spring 47, is operatively connected to the pressure space 14 via a line 25.

An actively controlled valve 48 thus at the same time also controls a passive valve 49. In a broadened functional variant, a bore 52 may be provided, in addition, in the piston 46 of the passive valve 49, in order to return the pressure medium into the pressure space 14.

1. A control device for a hydraulic control motor (41), with two valves (48,49) which in each case have pistons (12,46) with stepped diameters, which are mounted axially moveably and are loaded by springs (11,47), with the following features:
a) the first valve (48) is controllable by means of an actuating force, and its piston (12) forms, in a housing (4) a first pressure space (14) with an element (16) having a throttle point (17),
b) the piston (46) of the second valve (49) forms with the housing (4) a second pressure space (50) which is hydraulically connected to the first pressure space (14) via a line (25), in such a way that the second valve (49) can be co-controlled by the first valve (48), characterized by the following features:
c) the control device operates on the open-center principle,
d) the piston (12) of the first valve (48) and/or the piston (46) of the second valve (49) has a bore (19 or 52) which serves for the feed of pressure medium to the respective pressure space (14 or 50),
e) the bore (19 or 52) in the piston (12 or 46) is arranged in such a way that, when the piston (12 or 46 is pressed against the housing (4), the bore (19 or 52) is closed, in order to avoid leakages.

2. The control device as claimed in claim 1, characterized in that the first valve (48) is controllable via a throttle point (17) by means of a throttle needle (18).

3. The control device as claimed in claim 1, characterized in that the actuating force can be generated mechanically, electrically, electromagnetically, hydraulically or pneumatically.

4. The control device as claimed in claim 1, characterized in that the pistons (12,46) have sealing elements (13,51) which serve at the same time for sealing-off and for mounting.

5. The control device as claimed in one of the preceding claims, characterized
in that two line paths (9,10) are provided parallel to one another between an inflow (3) for a hydraulic pressure medium and a tank (2),
in that, as seen in the direction of the flow of pressure medium occurring during operation, there is first provided, in each of the two line paths, a controlling valve in the manner of the first valve (48), which is followed in each case by a co-controlled valve in the manner of the second valve (49),
in that, in each case, the co-controlled valve (49) arranged in one of the line paths is co-controlled by the controlling valve (48) of the other line path.
